(19) United States
(12) Patent Application Publication
(10) Pub. No.: US 2009/0247195 A1
(43) Pub. Date: Oct. 1, 2009

(54) MULTIMEDIA SYSTEMS

(75) Inventors: Jonathon Palmer, London (GB); Nicholas Allen, Reading (GB)

Correspondence Address: DAVID A. GUERRA;INTERNATIONAL PATENT GROUP, LLC, 2025 17TH AVENUE N.W., CALGARY, AB, T2M 0S7, CA

(73) Assignee: MADE COMMUNICATIONS, London (GB)

(21) Appl. No.: 12/112,898

(22) Filed: Apr. 30, 2008

(30) Foreign Application Priority Data
Mar. 25, 2008 (GB) 0805274.8

(51) Int. Cl. H04Q 7/20

(52) U.S. Cl. 455/466

(57) ABSTRACT

There is provided a method of enhancing a hard copy consumable printed item such as a greeting card or a calendar, with a digital package supported by a multi-media system, comprising the steps of: generating a digital package comprising digital content and/or services; making the digital package accessible to the multi-media system; manufacturing the printed item and including with the printed item a unique set of codes; storing in the multi-media system a mapping between the unique set of codes and the digital package; providing access to the digital packages to users of the printed items using the multi-media system on submission of the codes to the multi-media system. In this way the hard copy consumable is enhanced by a digital package which might include the ability to download pre-paid digital content and/or to access digital services.

### CROSS-REFERENCE TO RELATED APPLICATIONS

This application is a Paris Convention entry application based upon co-pending Great Britain Application No. 0805274.8 filed on Mar. 25, 2008. The entire disclosures of the prior applications are incorporated herein by reference.

### BACKGROUND OF INVENTION

The present invention relates to a hard copy printed consumer item, such as a greeting card, a calendar or a diary, enhanced by a digital package tailored to the consumer item and supported by a multi-media system.

Greeting cards are sent between individuals, for example on celebration days which may include generic celebration days, such as Christmas and Valentine's Day as well as person specific celebration days, such as birthdays and anniversaries. These greeting cards have traditionally been hard copy greeting cards made from paper and/or card or similar material. More recently, E-cards have been developed and used which are sent to PCs via e-mail or m-cards which are sent to mobile telephones.

Calendars have traditionally comprised hard copy booklets, generally showing a month on each page of the calendar and made from paper and/or card or other like material. Software packages are available providing calendar utility on a user's computing device or are available on-line via the internet. A user can personalize these calendars to provide them with reminders, for example before an event, such as a meeting or other deadline.

### SUMMARY OF INVENTION

According to the present invention there is provided a method of enhancing a hard copy consumable printed item such as a greeting card or a calendar, with a digital package supported by a multi-media system, comprising the steps of: generating a digital package comprising digital content and/or services; making the digital package accessible to the multi-media system; manufacturing the printed item and including with the printed item a unique set of codes; storing in the multi-media system a mapping between the unique set of codes and the digital package; providing access to the digital packages to users of the printed items using the multi-media system on submission of the codes to the multi-media system. In this way the hard copy consumable is enhanced by a digital package which might include the ability to download pre-paid digital content and/or to access digital services. The digital packages may typically be pre-paid digital assets which may be paid for when the item is purchased. Alternatively, it may be possible for a user to upgrade or pay for packages rather than them being prepaid.

The present invention provides a simple and convenient way of enhancing the experience associated with a greeting card, a calendar or a diary. In addition, the present invention secures the digital packages against unauthorized access using the set of codes. The hard copy consumable printed item may be an item which comprises spaces within the printed item for a user to write in. This is the case, for example in a greeting card, where a purchaser of the greeting card writes a personal message to a recipient of the greeting card. Also, in a diary or calendar, spaces are provided for a user to write appointments, etc. or reflections on their day. The user of the item interacts with the hard copy item by writing on it.

Generally the present invention would offer a plurality of digital packages and a plurality of hard copy consumable printed items.

The consumable item may be a greeting card, typically made from paper or card, or other like material. In this case, the digital package may be related to a theme of the greeting card. At least one of the codes of the set of codes may initially be covered, for example, with a removable covering or may for example, be obscured in the centre of a greeting card, until the card is opened. Where at least one of the set of codes is covered a sender may purchase the greeting card and send or give it to a recipient user and when the recipient user receives the greeting card they may uncover the set of codes on the greeting card. Covering the set of codes in this way inhibits access to the digital package by others than the recipient user.

Alternatively, the consumable item may be a calendar or a diary, in which case, the digital package may be linked to calendar dates. For example, the digital package might include text or e-mail alerts before approaching generic diary dates or diary dates personalized to the user. Again, the set of codes may be covered to inhibit access.

Unauthorized access to the digital package can be further inhibited by providing at least one of the codes in the set of codes as a separate unit, for example on a separate card stored separately from the greeting card, which is only matched and provided with the consumable item on purchase of that item by a user.

A convenient way of the user interacting with the multi-media system is by text message. In this case, the unique set of codes may include an SMS short code and a user may access their digital package by sending an SMS message, using the SMS short code, to the multi-media system in order to access the digital package. Alternatively, the unique set of codes might incorporate a web link, which a user can input into a web browser in order to access the digital package. In addition, the set of codes may include a unique code which a user provides to the multi-media system in order to access the digital package. The digital package may then be accessed, for example, by including the unique code in the SMS message sent by a user to the multi-media system.

Access to the digital package may be provided by the user sending a digital message (e.g. SMS, MMS or e-mail) from a user's electronic device (e.g. mobile telephone or computing device) to the multi-media system using the set of codes. The multi-media system may then verify the set of codes and if the codes are verified, the multi-media system sends a digital message to the user's electronic device including a link to an internet site hosting the digital package. Then the user may access the digital package using the link. The multi-media system may generate the internet site itself, for example as a micro-site or web portal, which may be a temporary micro-site or web portal.

This document refers to internet sites, web sites, web portals and web pages, which refer to pages viewed from a web browser on a digital electronic device which supports web browsing, such as a mobile phone or a personal computer (PC).

In order to further inhibit access by unauthorized users, the multi-media system may store the digital address of the user's electronic device (for example, a mobile phone number), mapped to the set of codes and may provide access to the link to the digital package, only from the digital address mapped to the set of codes.

Alternatively, unauthorized access to the packages can be prevented by providing a personal identification number (pin number) in the digital message to the user's electronic device. In this case the user may access the digital package using the link by inputting the pin number on the internet site.

When the multi-media system sends the link to the internet site to the user, the link may be time stamped so that it expires after a predetermined time period. Thereafter, use of the link could not be used to access the digital package. In addition, the multi-media system may mark the digital package as redeemed once the digital package has been used, for example once a digital service has been accessed or digital content has been downloaded. Thereafter, access to the digital package using the set of codes is prevented. This further prevents unauthorized access to the digital package.

In certain cases, it may be possible for a user to personalize the digital package, for example by selecting from a number of options of digital content and/or services. Where the item is a calendar, the digital package might be personalized by adding dates personal to the user, such as birthdays and anniversaries, which could then be used a basis for sending reminder messages to the user. This may be done by the user accessing the internet site to personalize the digital package (or by other digital means e.g. SMS).

The present invention also provides a multi-media system for enhancing a hard copy consumable printed item with a digital package, comprising: at least one digital package comprising digital content and/or services; the printed item comprising a unique set of codes; and a system processor for accessing the digital packages, for storing a mapping between the unique set of codes and the digital package and for providing access to the digital packages to users of the printed items on submission of the codes.

In some cases, the digital packages may be provided by content providers separate from the multi-media system, in which case the system processor may comprise means for accessing the digital packages from at least one content provider.

The set of codes may include a unique code which is provided by a user to the system processor in order to access the digital package and to prevent unauthorized access to the digital package.

Again, the unique set of codes may include an SMS short code and the multi-media system may comprise an SMS interface for receiving an SMS message from a user's electronic device. In particular, the SMS interface may comprise means for receiving an SMS message from a user's electronic device and for forwarding any of the unique set of codes and optionally a digital address for the user's electronic device (for example a mobile phone number) in the message to the system processor.

The multi-media system may additionally comprise a database accessible to the system processor for storing the mapping. In this case, the system processor and database may comprise means for storing the electronic device's digital address on the database mapped to the unique code.

The system processor may comprise means, responsive to a user sending a digital message from a user's electronic device to the multi-media system using the set of codes, for verifying the set of codes. This is a measure for preventing unauthorized access to the digital packages and if the codes are not verified, access to the packages may be denied. If the codes are verified, then the system processor may comprise means, responsive to the verification of the codes, for sending a digital message via the SMS interface to the user's electronic device which message includes a link to an internet site hosting the digital package.

In addition, the system processor may comprise means for verifying the digital address of the user's electronic device and on verification may comprise means for connecting only the user's electronic device, i.e. that device using the verified digital address, to the internet site. Again this is a measure for preventing unauthorized access to the digital packages.

For additional security, the system processor may comprise means for generating a pin number, storing the pin number on the database mapped to the unique code and for including in the digital message to the user's electronic device the personal identification number (pin number) as well as the link to the internet site.

When a user receives the link to the internet site, they may activate the link. In this case, the system processor may comprise means, responsive to the receipt of the link, for providing access by the user to a web page into which the pin number can be input. In addition, the system processor may comprise means, responsive to the inputting of the pin number, for accessing the database to verify the pin number and the system processor may comprise means responsive to verification of the pin number for connecting the user to the internet site hosting the digital package.

Again, the system processor may comprise means for generating the web page and/or the internet site, which may be a micro-site or web portal. The micro-site or web portal may be temporary and may be time stamped so that they expire after a predetermined time period. Thereafter, the micro-site or web portal is not accessible.

The system processor may comprise means for personalizing the digital package in response to preferences input into the internet site by the user.

The present invention also provides a hard copy consumable printed item, such as a greeting card, calendar or diary, comprising a unique set of codes suitable for enhancement by the multimedia system described above.

### BRIEF DESCRIPTION OF DRAWINGS

The invention will now be described by way of example only and with reference to the accompanying schematic drawings, wherein:

FIG. 1a shows a front view of a multi-media greetings card according to the present invention and FIG. 1b shows an inside view of the greeting card of FIG. 1a;

FIG. 2 shows three embodiments of a hidden code and covering which may be located on an internal surface of the greeting card of FIG. 1;

FIG. 3 shows an architecture of a multi-media greeting card system according to the present invention incorporating the greeting card of FIGS. 1 and 2;

FIGS. 4a to 4c shows example messages incorporating unique links which are sent to a recipient's mobile telephone by the multi-media system of the system of FIG. 3;

FIG. 5 shows a system architecture showing the operating of the multi-media system of FIG. 3 to send a ‘Thank you’ response;

FIG. 6 shows a system architecture showing the operating of the multi-media system of FIG. 3 to redirect a recipient to a content provider website;

FIGS. 7a and 7b show the data model for the multi-media system of the present invention;

FIG. 8a shows a front view of a multi-media calendar according to the present invention and FIGS. 8b and 8c show inside booklet pages of the calendar of FIG. 8a;

FIG. 9 shows an architecture of a multi-media calendar system according to the present invention incorporating the calendar of FIGS. 8a to 8c;

FIG. 10 shows a flow diagram showing the process of manufacture of the calendar of FIGS. 8a to 8c including the interaction with the multi-media system of FIG. 9;

FIG. 11 shows a flow diagram of the process of activation and configuration of the multi media system of FIG. 9 using information provided on the calendar of FIGS. 8a to 8c;

FIG. 12 shows a flow diagram of the process of the multi-media system of FIG. 9 sending messages to a user of the calendar;

FIG. 13 shows the architecture of a multi-media system of the type shown in FIG. 9;

FIG. 14 shows a flow diagram of the process of configuration of the multi-media systems of FIGS. 9 and 13 using a mobile telephone;

FIG. 15 shows a flow diagram of the process of configuration of the multi-media systems of FIGS. 9 and 13 using a computing device; and

FIGS. 16a to 16c shows a greeting card to which a unique code is added on purchase of the card.

### DESCRIPTION OF THE PREFERRED EMBODIMENTS

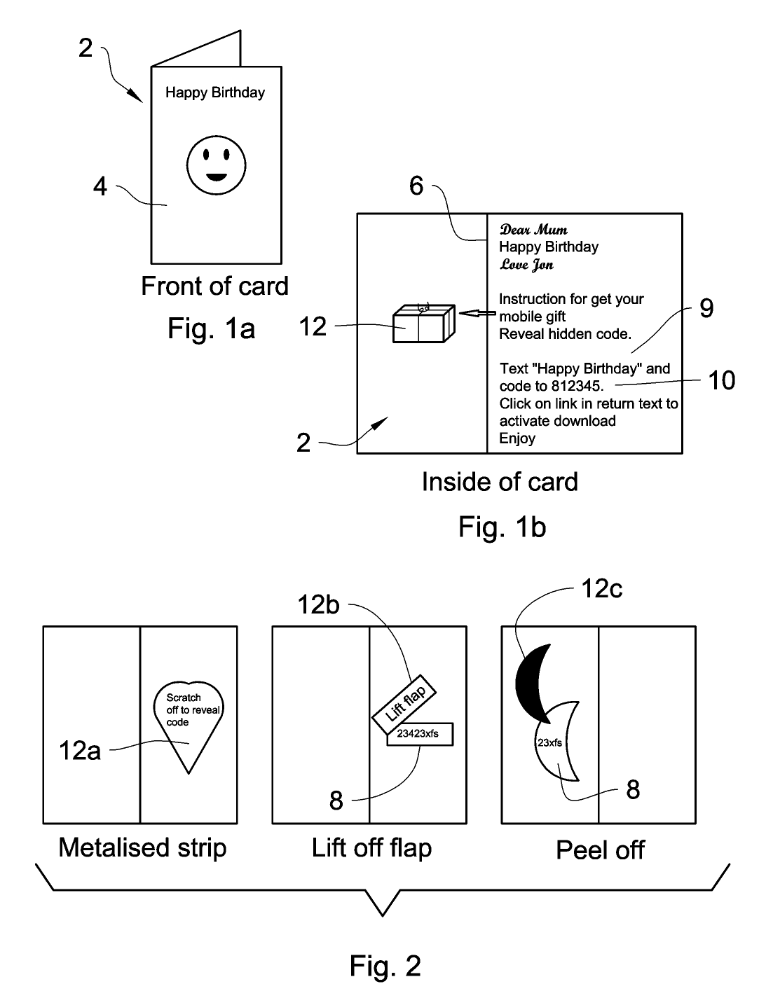

The multi-media greeting card (2) shown in FIGS. 1a and 1b comprises a traditional hard copy folded greeting card, for example made from card or paper or other like material. The greeting card may for example be folded to generate an exposed front surface (4) and an internal surface (6) which is at least partially obscured when the card is folded. For example, the greeting card may present an image on at least its front surface (4) and a printed message on its internal surface (6), which can be accessed by unfolding the card. A sender of the greeting card will typically write a personal message to a recipient of the card on the internal surface (6).

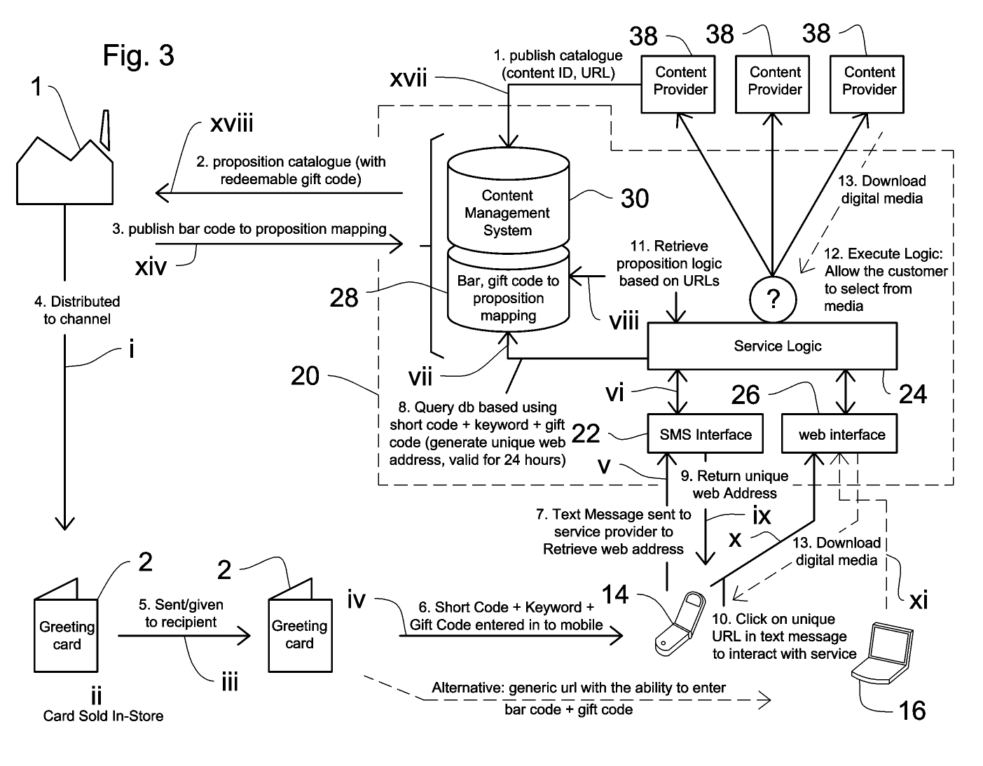

The greeting card (2) includes a hidden or obscured unique code (8), a keyword (9) (in this example ‘Happy Birthday’) and a communication code (10). The communication code (10) may be a short message service (SMS) short code that gives access to a multi-media system (20) shown in FIG. 3, via an electronic device supporting SMS, typically a mobile telephone (14) or other electronic device which incorporates mobile telephone capabilities. Alternatively, the communication code (10) may be a universal resource locator (URL) or hyperlink that gives access to the multi-media system (20) via an electronic device supporting internet communication, such as a computing device (16) supporting internet connectivity.

As shown in FIG. 1b the SMS short code (10) may be printed on the internal surface (6) of the card as part of the printed message. The unique code (8) is hidden from view until the greetings card (2) is purchased, removed from a wrapping and unfolded and so may be located on a part of the internal surface (6) of the card which is obscured when the card is folded. In addition, as shown in FIGS. 1b and 2, the unique code (8) may be hidden behind a covering (12) so that the unique code is obscured even when the card is opened. The unique code (8) and covering (12) may be located on the internal surface (6) of the greeting card. The covering (12) may for example comprise: a layer of opaque material (12a) which can be scratched off to reveal the unique code, for example using an edge of a coin; a lift off flap (12b) which can be lifted to reveal the unique code (8); or a peel off sticker (12c) which can be peeled off a surface of the card so as to reveal the unique code (8). Instructions are also provided on the card (2) to instruct a recipient of the card how to access the multi-media system (20). Other removable coverings (12) are available in the art which could be used to obscure the unique code (8) and then be removed to reveal the unique code as required.

The multi-media system (20) provides digital content and/or digital services. The codes (8, 9, 10) printed in the greeting card (2) provide free access to a package of digital content and/or services, which package is paid for upon purchase of the greeting card by a sender of the card. Therefore, the package acts as a gift to a recipient of the greeting card (2) and enhances the experience of receiving a traditional greeting card.

Referring now to FIG. 3, in order to populate the code database (28) and content management systems (30) of the multi-media system (20), content providers (38) publish a digital packages (propositions) catalogue to the multi-media system [step xvii in FIG. 3]. Each package is associated in the catalogue with a supplier identifier to uniquely identify the package. Each package is identified by a unique identifier which may be the supplier identifier or may be linked to the supplier identifier for the package and is then mapped to an SMS short code (10), keyword (9) and unique code (8) by the content management system (30) and the mapping is stored on the database (28). A catalogue is then supplied to the greeting card manufacturer (1) [step xviii in FIG. 3], showing the available packages linked with the associated unique codes (8), keywords (9) and SMS short codes (10). The manufacturer (1) then manufactures the greeting cards (2) containing the SMS short code (10), keyword (9) and unique code (8) associated with the digital package the greeting card offer as shown in FIGS. 1 and 2. The manufacturer may optionally provide the multi-media system (20) with a mapping between the bar code for each type of greeting card (2) it manufactures and the SMS short code (10), keyword (9) and unique code (8) [step xiv in FIG. 3]. This mapping can also be stored in the database (28) so that the bar code can provide another unique key to download digital packages.

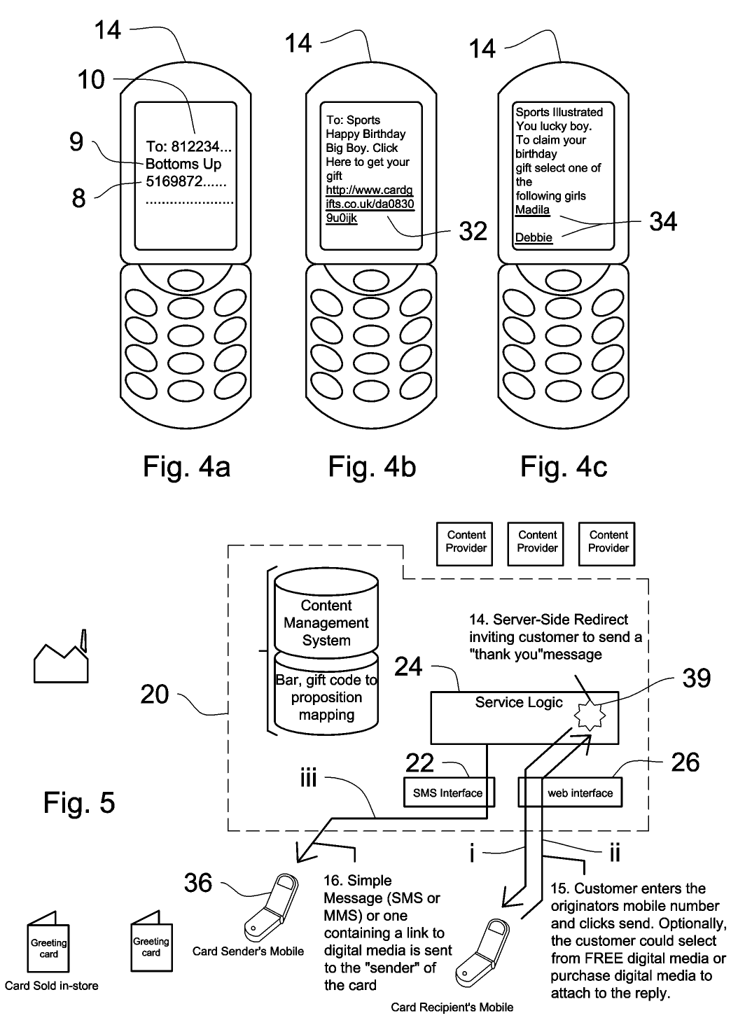

The greeting card (2) is distributed to retail outlets [step i in FIG. 3], including on-line retail outlets. The greeting card (2) is then purchased by a sender of the greeting card [step ii in FIG. 3], for example, from a retail outlet. The sender then sends or gives the greeting card to the recipient [step iii in FIG. 3]. Alternatively, the sender may purchase the greeting card on-line, add a personal message on-line and then the greeting card (2) is sent to the recipient by the on-line retailer. On receiving the greeting card (2) the recipient opens the card and can follow instructions on the card to reveal the unique code (8), for example, by removing the covering (12). The recipient then follows the instructions on the card and generates an SMS message using a personal electronic device, supporting SMS messaging, for example their mobile phone (14), addressed to the SMS short code number (10) [step iv in FIG. 3]. The body of the SMS message contains the keyword (9) and the unique code (8) and is addressed to the SMS short code (10), as is shown on the mobile phone (14) in FIG. 4a. The recipient then sends the SMS message [step v in FIG. 3] in order to access the digital content or services included in the package.

The multi-media system (20) comprises a system processor, for example, central server (24), an SMS interface (22), a web interface (26), a code database (28) and a digital content and services management system (30).

The multi-media system (20) receives the SMS message at SMS interface (22) and the system processor (24) retrieves a set of data comprising the unique code (8), keyword (9), SMS short code (10) and the recipient's mobile phone number [step vi in FIG. 3] and interrogates the code database (28) with this set of data [step vii in FIG. 3]. The code database (28) stores mappings between digital content or services packages and sets of data comprising unique codes (8), keywords (9) and SMS short codes (10). A further mapping between the sets of data and the user's digital address (e.g. mobile phone number) may also be stored at this stage in the code database (28). The code database (28) uses the mappings to identify the package associated with the received unique code (8), keyword (9) and SMS (10) short code and forwards to the system processor (24) the unique identifier. For example, the identifier may be a hyperlink or a URL to the identified package [step viii in FIG. 3]. The system processor (24) then forwards the unique package identifier to the recipient's mobile phone (14) via the SMS interface (22) [step ix in FIG. 3] using the recipient's mobile phone number.

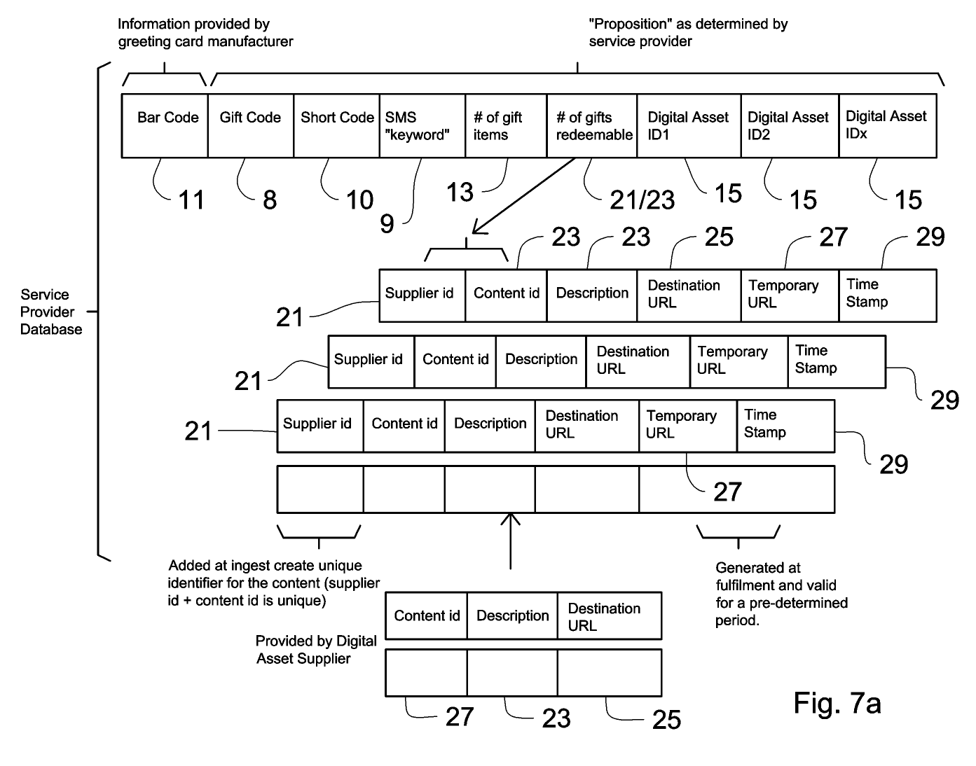

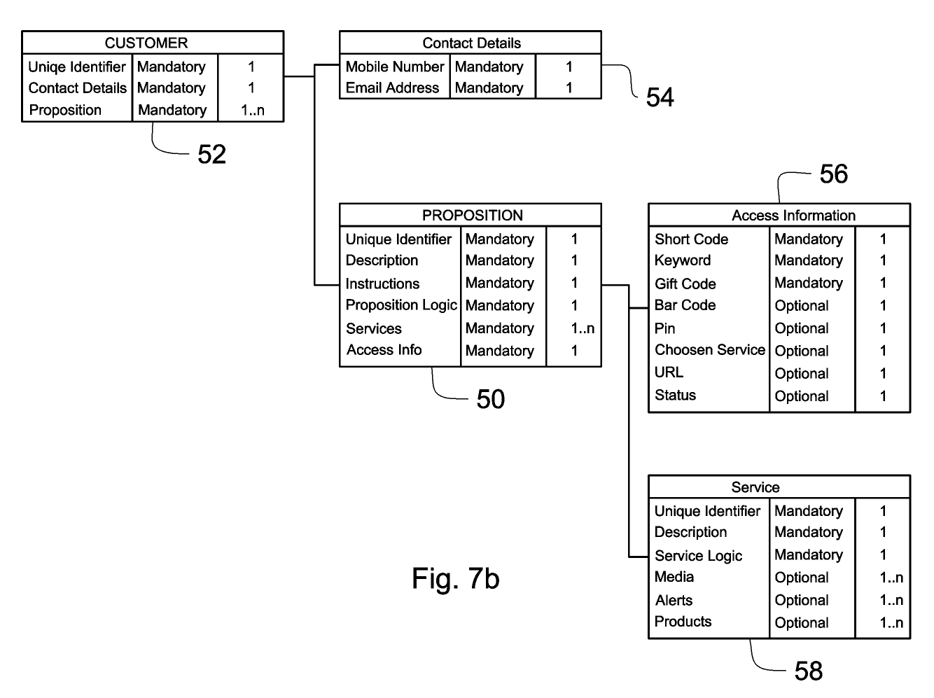

Examples of messages incorporating the unique identifier sent to the recipient's mobile phone (14) are shown in FIGS. 4b and 4c. In FIG. 4b the unique identifier is a URL (32) and in FIG. 4c the unique identifier is a set of hyperlinks (34) from which the recipient can select. The unique identifier may be made valid for only a set period of time, for example 24 hours, for example by making the link a temporary link, such as a temporary URL and by time stamping the temporary URL (See 27, 29 of FIG. 7a). The temporary URL is then accessed by the recipient in order to access their digital package. The temporary URL expires after the set period of time and thereafter the digital package is not accessible to the recipient.

Optionally the unique identifier may only be interpreted by the multi-media system (20) as valid if the unique identifier is used from the recipient's mobile phone number (digital address) which is stored on the multi-media system (20). The message incorporating the unique identifier may include an extension to the creative motif of the greeting card (2), for example a punch line to a joke or an answer to a question posed in the card. The content or services themselves may also be an extension of the motif of the card.

The recipient, then activates the unique identifier, for example by clicking on the URL (32) or hyperlink (34) [step x in FIG. 3] (which may be time stamped and temporary) and the multi-media system (20) connects the recipient's mobile phone with the digital package from a content provider's website (38) associated with the unique identifier, via the web interface (26) and system processor (24). This may be done by the system processor (24) using the unique identifier to generate a micro-site (web portal) using content from the content provider's website (38) based on the set of data mapped to the unique identifier on the code database (28). Once the pre-paid digital package has been used, for example, a pre-paid amount of digital content downloaded to the recipient's mobile phone or a pre-paid amount of digital service has been used, and/or once the set time period has elapsed, the system processor (24) interrogates the code database (28) to mark the set of codes as redeemed. Further attempted access to the digital package, using the redeemed set of codes, is thereafter denied by the system processor (24).

For recipients of greeting cards (2) who do not have a mobile phone (14) supporting internet connectivity or who do not wish to use their mobile phone, an alternative route can be provided for accessing their digital package. In this case, the unique identifier is a URL which can be accessed via a computing device, such as a personal computer (PC) (16). The recipient then types the URL into the web browser on their PC (16) and the system processor (24) on receiving the URL via the web interface (16) [step xi in FIG. 3] generates the micro-site, as described above and the recipient interrogates the micro-site to access their package from the PC (16) via the web interface (26).

The digital packages associated with the greeting card multi-media system according to the present invention may include the downloading of images, video files, audio files, games and ringtones, which the recipient may have the option to save or store on their mobile phone (14) or PC (16). Alternatively, the digital package may provide access to digital content through streamed delivery systems. The digital packages might include access to digital services, such as interactive services in which the recipient plays a game, answers questions or enters a competition (e.g. a lottery), which may allow the recipient to win prizes if they are successful. The digital package might also enable the recipient to redeem a pre-paid ticket to an event, a coupon or a barcode through other digital service providers, such as digital retail service providers (on-line shops) or at physical locations, such as retail outlets. Alternatively, the digital package might comprise multiple downloads over a predetermined period of time and to a schedule, for example, periodic texts providing horoscopes.

Examples of greeting cards (2) and associated digital packages are set out below:
1. A sender purchases a football team branded greeting card for a recipient. The recipient's digital package enables the recipient to download that football team's branded wallpaper for their mobile phone. The recipient may then be redirected to that football team's website.
2. A sender purchases a pop group branded greeting card for a recipient. The recipient's digital package enables the recipient to download and save that pop band's latest single.
3. A sender purchases a film branded greeting card for a recipient. The recipient's digital package enables the recipient to download and save a game related to the film, which can then be played by the recipient.
4. A sender purchases a film branded greeting card for a recipient. The recipient's digital package enables the recipient to download pre-paid cinema tickets to the latest installment of that film. The tickets could then be redeemed at a participating cinema operator by presenting their mobile phone and/or providing relevant information from the downloaded tickets.
5. A sender purchases a TV game show branded card for a recipient. The recipient's digital package enables the recipient to play a game following a similar format to the TV game show. If the recipient is successful at the game they may be able to win funds.

In one embodiment, shown in FIG. 5, the recipient of the greeting card (2) is offered the opportunity to send a digital ‘Thank you’ response to the sender. Upon redemption of the package by the recipient, the service processor, redirects the recipient to a thank you message (TYM) web page (39) hosted by the service processor (24) [step i of FIG. 5], via the web interface (26) inviting them to reply to the sender of the greeting card (2). FIG. 5 shows the reply in the form of an SMS message, but alternative messaging systems could be used, such as multi-media messaging service (MMS) or e-mail. Once redirected to the TYM web page the recipient enters the sender's address, e.g. mobile phone number, e-mail address, etc. and clicks send [step ii of FIG. 5]. Optionally, the TYM web page might allow the recipient to select free digital content to send with the message to the sender, or might allow the recipient to purchase digital content to send with the message to the sender. The service processor (24) then generates the SMS message which is then sent to the mobile phone (36) of the sender by the service processor via the SMS interface (22) [step iii of FIG. 5]. The SMS message may optionally include a link to any digital content selected by the recipient.

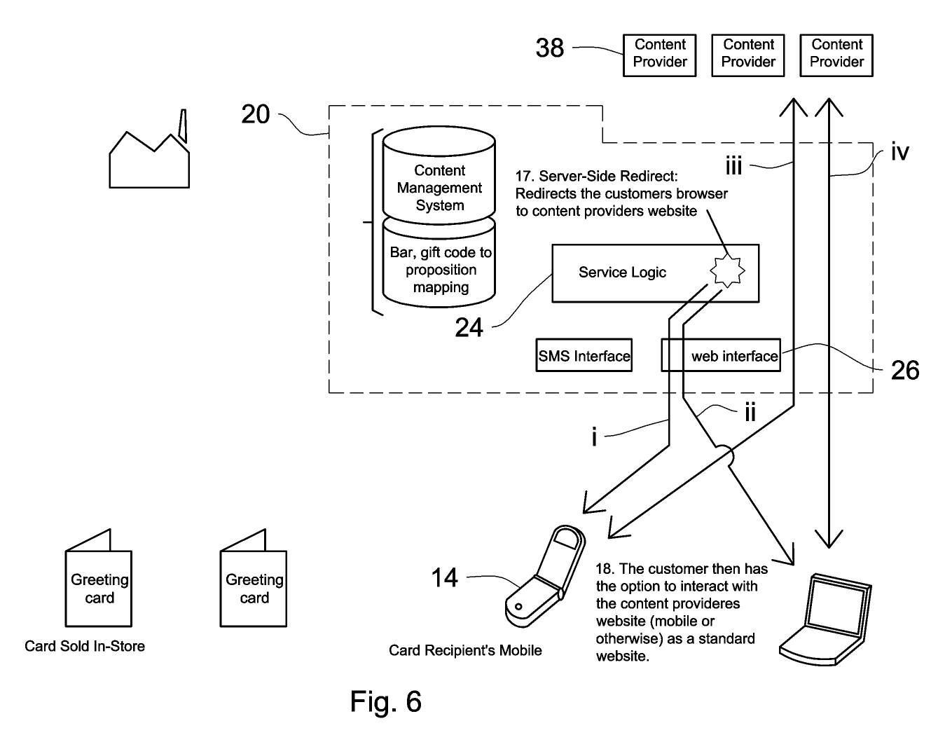

In addition or alternatively, on redemption of the package or on completion of the sending of the ‘Thank you’ message, the recipient may be redirected to the web site of the service provider (38) who provided the content of the package, as shown in FIG. 6. The service processor (24) acting via the web interface (26) redirects the recipient's browser on their mobile phone (14) [step i in FIG. 6] or on their PC (16) [step ii in FIG. 6] to the website of the service provider (38) and the recipient then interacts with the web service of the content provider (38) as a standard web page [step iii or iv in FIG. 6].

A further embodiment of this invention relates to a multi-media calendar or diary.

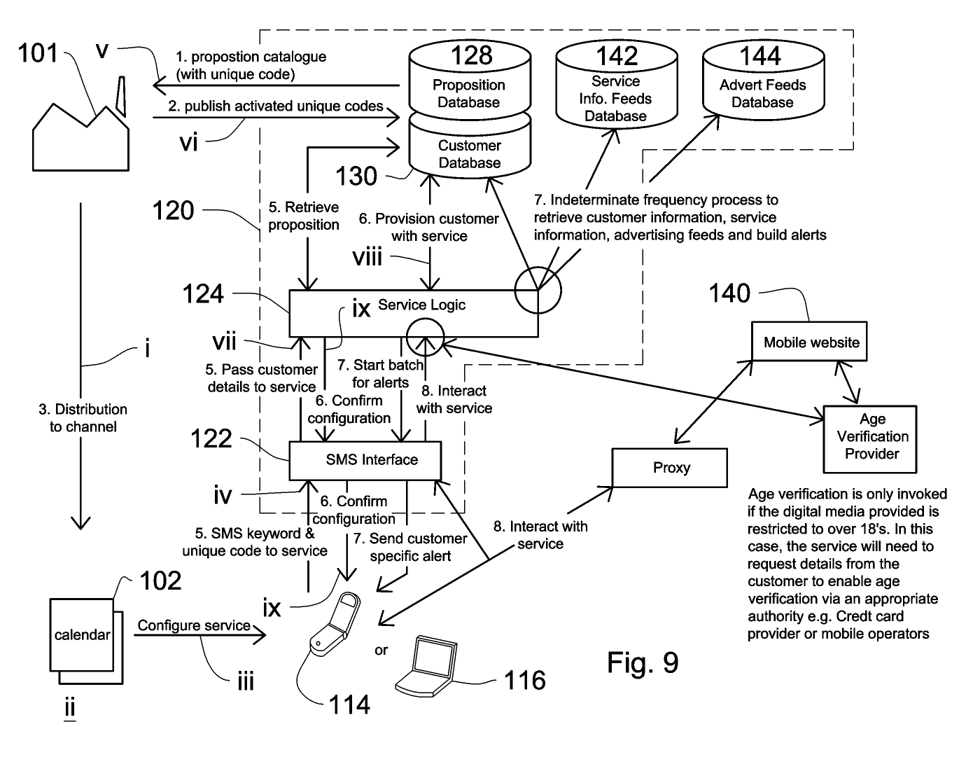

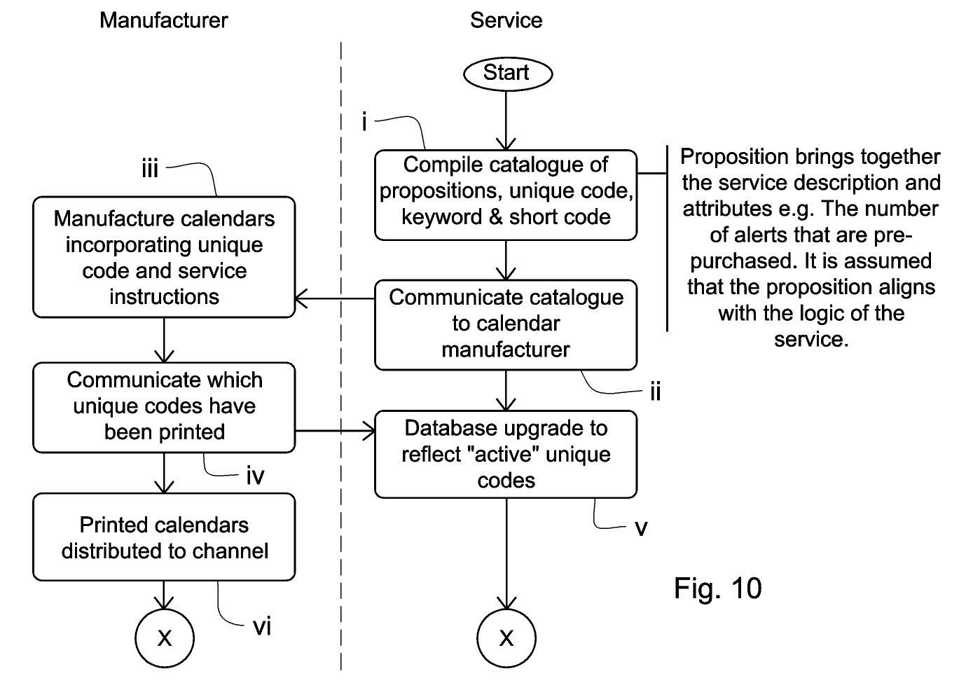

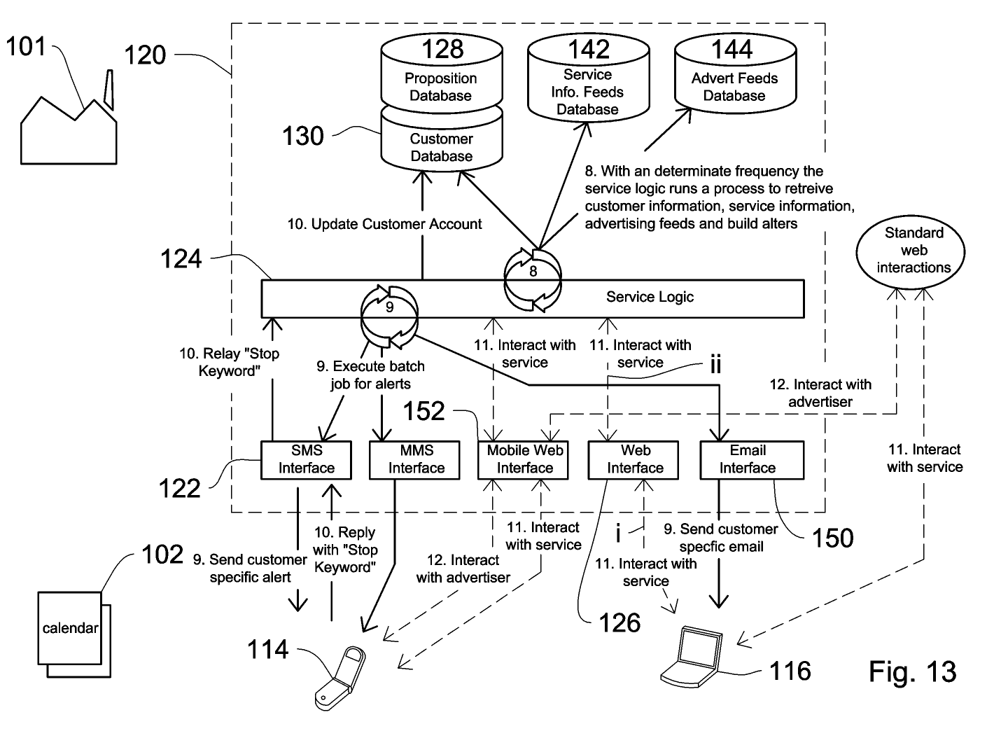

The multi-media calendar system is shown in FIGS. 9 and 13 and comprises a multi-media system (120) and a hard copy calendar (102). An operator of the multi-media system compiles a catalogue [step i in FIG. 10] and publishes the catalogue to a hard copy calendar manufacturer (101) [step ii in FIG. 10; step v in FIG. 9]. The catalogue contains all the information to be printed in the calendar to enable a user of the calendar to access a digital package. The catalogue contains a list of unique codes mapped to a description of the digital package and a communication code (110), which may be an SMS sort code or a URL and a keyword (109). The digital package is described as a description of the digital content or services and the schedule of access to the digital content or services through the time period, for example, a calendar year covered by the hard copy calendar (102). This information is stored in a proposition database (128) of the multi-media system (120) (See FIGS. 7a and 7b).

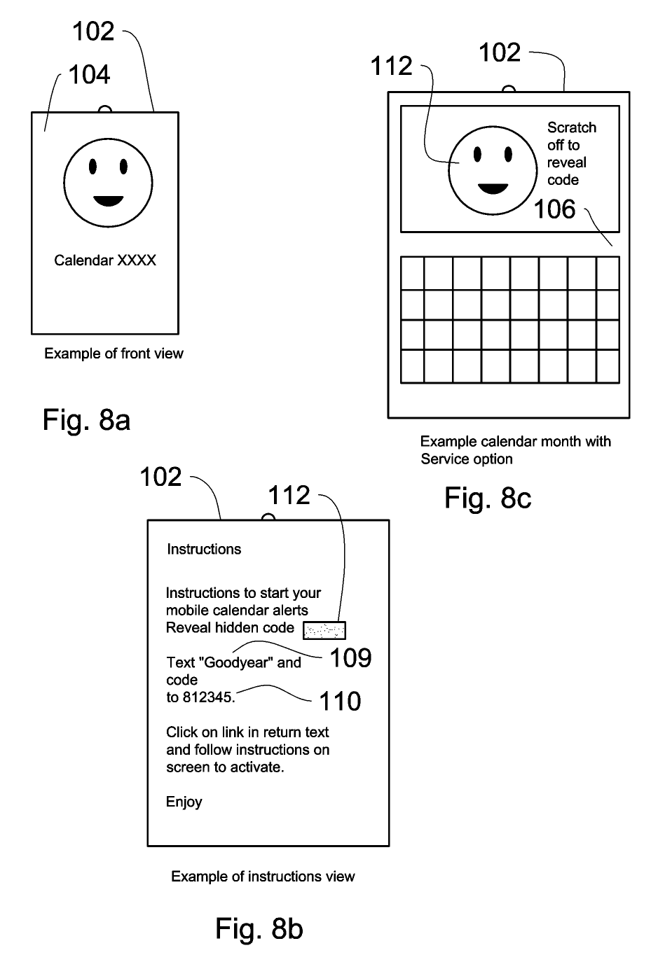

The calendar manufacturer (101) uses the catalogue to print calendars (102) [step iii of FIG. 10] containing the unique code, communication code (110) and keyword (109), a description of the digital package provided with the calendar and instructions on how to access the digital package, as described below in relation to FIGS. 8a to 8c. The calendar manufacturer (101) records which unique codes have been printed and may also include a mapping of the bar code (See (11) in FIG. 7a) for each calendar type to the unique codes printed on them and sends this to the multi-media system (120) [step iv of FIG. 10; step vi of FIG. 9] and this mapping is stored in the proposition database (128) mapped to the other information stored in the database for the associated unique codes [step v of FIG. 10] and the digital package is marked as active.

The multi-media calendar (102) shown in FIGS. 8a to 8c comprises a traditional hard copy calendar, for example made from card and/or paper or other like material. The calendar may be in the form of a booklet with an exposed front page (104) shown in FIG. 8a, a plurality of internal booklet pages (106) each displaying a month calendar view, as shown in FIG. 8c, and a page displaying instructions, as shown in FIG. 8b, for using a multi-media system (120) shown in FIGS. 9 and 13.

This embodiment of the invention can equally be applied to a hard copy diary. The only difference being that the diary might display, for example a single day on each page of the diary or a single week on opposing pairs of diary pages.

The calendar (102) includes a hidden or obscured unique code, optionally covered by a removable covering (112), a keyword (109) (in this example ‘Goodyear’) and a communication code (110). The communication code (110) may be short message service (SMS) short code that gives access to the multi-media system (120) shown in FIG. 9, via an electronic device supporting SMS, typically a mobile telephone (114) or other electronic device which incorporates mobile telephone capabilities. Alternatively, the communication code (110) may be a universal resource locator (URL) that gives access to the multi-media system (120) via an electronic device supporting internet communication, such as a computing device (116) supporting internet connectivity.

The unique code is protected from tampering. For example it may be protected from view, until the calendar (102) is purchased, removed from a wrapping and opened and so may be located on an inside booklet page of the calendar which is obscured when the calendar booklet is closed. In addition, as shown in FIGS. 8b and 8c, the unique code may be hidden behind a covering (112) so that the unique code is obscured. The covering (112) may be similar to that described above in relation to the greeting card (2).

The multi-media system (120) provides digital content and/or digital services. The codes printed in the calendar (102) provide free access to a package of digital content and/or services, which package is paid for upon purchase of the calendar. Alternatively, it may be possible for the user to upgrade and pay for packages rather than it be prepaid.

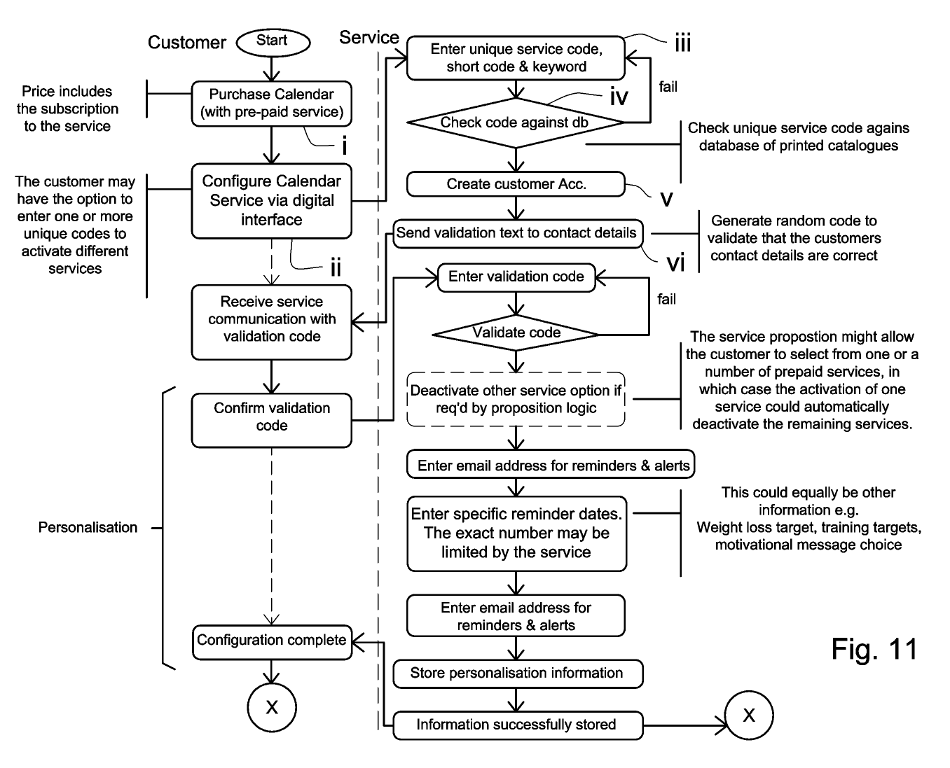

The calendar (102) is distributed to retail outlets, which include on-line retail outlets [step vi in FIG. 10; step i in FIG. 9] and is then purchased by a purchaser who intends to use the calendar themselves or to give it to a recipient [step i in FIG. 11; step ii in FIG. 9]. The user of the calendar (102) can follow instructions on the calendar to reveal the unique code, for example, by removing the covering (112).

Where the unique code is an SMS short code, the calendar user then follows the instructions on the calendar and generates an SMS message using a personal electronic device, supporting SMS messaging, for example their mobile phone (114), addressed to the SMS short code number [step iii in FIG. 9]. The body of the SMS message contains the keyword (109) and the unique code and is addressed to the SMS short code (110). The calendar user then sends the SMS message [step ii in FIG. 11; step iv in FIG. 9] in order to configure their digital package.

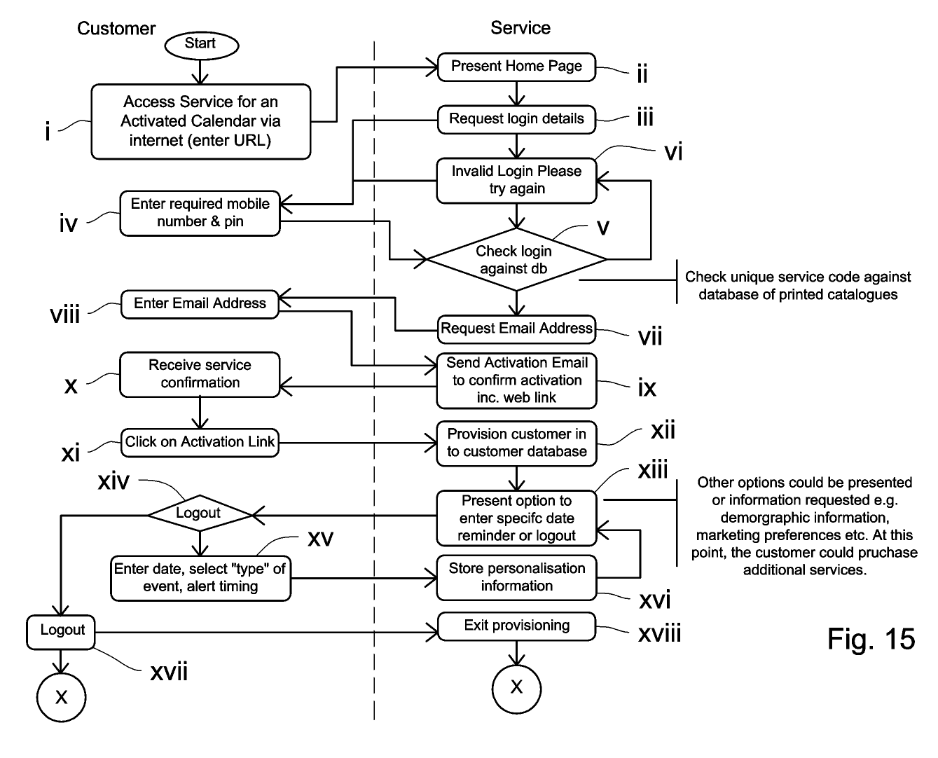

The multi-media system (120) receives the SMS message at SMS interface (122) and the system processor (124) retrieves a set of data comprising the unique code, keyword (109), SMS short code (110) and the recipient's mobile phone number [step vii in FIG. 9] and interrogates the proposition database (128) with this set of data [step iii in FIG. 11; step viii in FIG. 9]. The proposition database (128) checks that the codes supplied are valid [step iv in FIG. 11; step viii in FIG. 9] and if they are, continues with the service by creating a customer account in the customer database (130) [step v in FIG. 11]. The customer database (130) stores a mapping between the user's digital address, e.g. mobile phone number and the package and registers an activation date for the package. The system processor (124) then generates an SMS message which it sends via the SMS interface (122) to the user's mobile telephone (114) stating that the digital package has been activated [step vi in FIG. 11; step ix in FIG. 9]. At this point the multi-media system may optionally send a further text messages to the user's mobile telephone (114) via the SMS interface (122) instructing the user how to personalize their package, for example, via return SMS messages, or by providing a link to a mobile website (140) from where the user can personalize their package, as described below. If the codes are invalid then the system processor (124) sends a message to the calendar user's mobile phone (114) stating that the codes were invalid and the service ceases.

Where the unique code is a URL, the calendar user then follows the instructions on the calendar and types in the URL to the web browser of their PC (116) in order to configure their digital package. Different digital packages can be offered in the hard copy calendar (102) and a corresponding number of communication codes (110) keywords (109) and unique codes (112) can be included. The calendar users select which package they want and use the appropriate code combination. Once the package has been activated on the multi-media system (120), the unselected packages are marked redeemed on the customer database (130) so that no further packages can be activated. In this way the calendar user is able to configure their digital package by communicating with the system process (124) via a web interface (126) [steps i and ii of FIG. 13]. A configuration process similar to that of FIGS. 9 and 11 can then be carried out between the calendar user's PC and the system processor (124) via the web interface (126), as described below in relation to FIG. 15.

The different packages are available regardless of the digital electronic device via which they are access, for example, mobile phone (114) or PC (116).

The package may be set with automatic reminders around celebration days, for example, Valentine's Day, Mother's Day and Father's Day. In addition the calendar user might personalize their package by adding other significant dates, such as, birthdays and anniversaries. The multi-media system can then provide reminders, for example SMS messages, to the calendar user's mobile telephone (114), for example up to 2 weeks prior to a significant date and can also attach to the message adverts for services accessible via a hyperlink or URL or as an image sent with the message, optionally with a discount or special offer. The multi-media system (120) may also duplicate the reminder to the calendar user's e-mail address, via an e-mail interface (150) where this has been uploaded to the multi-media system when the calendar user configures the package.

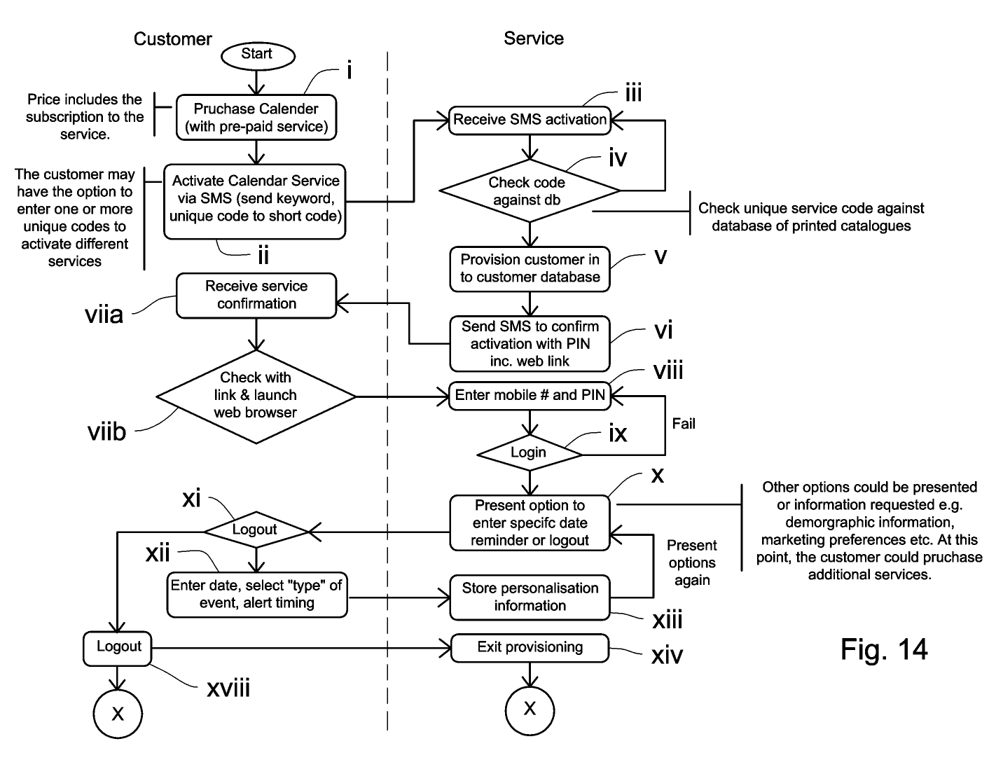

The calendar user purchases a calendar [step i of FIG. 14] and sends an SMS message [step ii of FIG. 14] to the multi-media system (120) including the unique code, keyword (109) addressed to the SMS short code (110) in order to activate and configure the package. The multi-media service receives the message [step iii of FIG. 14], checks the codes are valid [step iv of FIG. 14], updates the customer database (130) [step v of FIG. 14] and sends a confirmation of activation message to the calendar user [steps vi of FIG. 14] which is received by the calendar user [step viia of FIG. 14] in a similar way as is described above in relation to FIG. 11. The SMS confirmation of activation message may contain a personal identification number (pin number) and a web link, for example a hyperlink or a URL.

The process of configuring the package from a mobile handset (116) is shown in FIG. 14. On receipt of the confirmation of activation message the calendar user may click on the web link to a package configuration web page and launch a web browser hosted on their mobile phone (114) [steps viib of FIG. 14] to access the web page. The calendar user is then prompted by an access page of the package configuration web page to input their mobile phone number and pin number [step viii of FIG. 14]. If this login process [step ix of FIG. 14] is successful the calendar user can access the package configuration web page to configure their package by adding personal information [steps x, xi and xii of FIG. 14] and this information is stored by the system processor (124) in the customer database (130) [step xiii of FIG. 14]. The user can then logout of the package configuration web page [steps xi, xiii and xiv of FIG. 14].

An equivalent process for configuring the package from a PC (116) is shown in FIG. 15. The calendar user accesses the system processor (124) via the web interface (126) by typing the web link that they received in the SMS message from the multi-media system (120) in the form of a URL into the web browser of their PC [step i of FIG. 15] and this gains the user access to a home page [step ii of FIG. 15]. The home page requests login details to the multi-media system (120) [step iii of FIG. 15] including the pin number received by the user in the SMS message from the multi-media system (120). The user then inputs their mobile phone number and pin number [step iv of FIG. 15] and if this login process is successful [steps v and vi of FIG. 15] the web page requests the user to input their e-mail address, which the user then enters [steps vii and viii of FIG. 15]. The system processor (124) then sends an activation e-mail to the user's PC (116) via the e-mail interface (150) including an activation link, for example a hyperlink [step ix of FIG. 15]. On receipt of the activation e-mail the user clicks on the activation link [steps x and xi of FIG. 15] and then the user can enter information personalizing their package, which information is stored in the customer account database (130) mapped to their pin number and their other unique codes stored in the database [step xii of FIG. 15]. The user can access the package configuration web page to configure their package by adding personal information [steps xiii, xiv and xv of FIG. 15] and this information is stored by the system processor (124) in the customer database (130) [step xvi of FIG. 15]. The user can then logout of the package configuration web page [steps xiv, xvii and xviii of FIG. 15].

The web page can offer the user different package options, which the user can select when they are configuring their package. In addition the calendar user can access different package options throughout the time period covered by the calendar.

The messages sent by the multi-media system (120) to the calendar user may not only be reminder messages, they may also be messages containing interesting facts or inspirational quotes linked to a theme or creative design of the hard copy calendar (102).

There is a wide variety of different types of interaction that would be possible between the multi-media system (120) and the calendar users. One example might be playing a game. By playing the game the user could potentially win a prize of some kind which they could redeem. Alternatively, the user might provide information, for example weight loss information, which could be stored on the customer database (130) and then calculations or analysis performed on the data and a summary given to the user, for example weight loss progress.

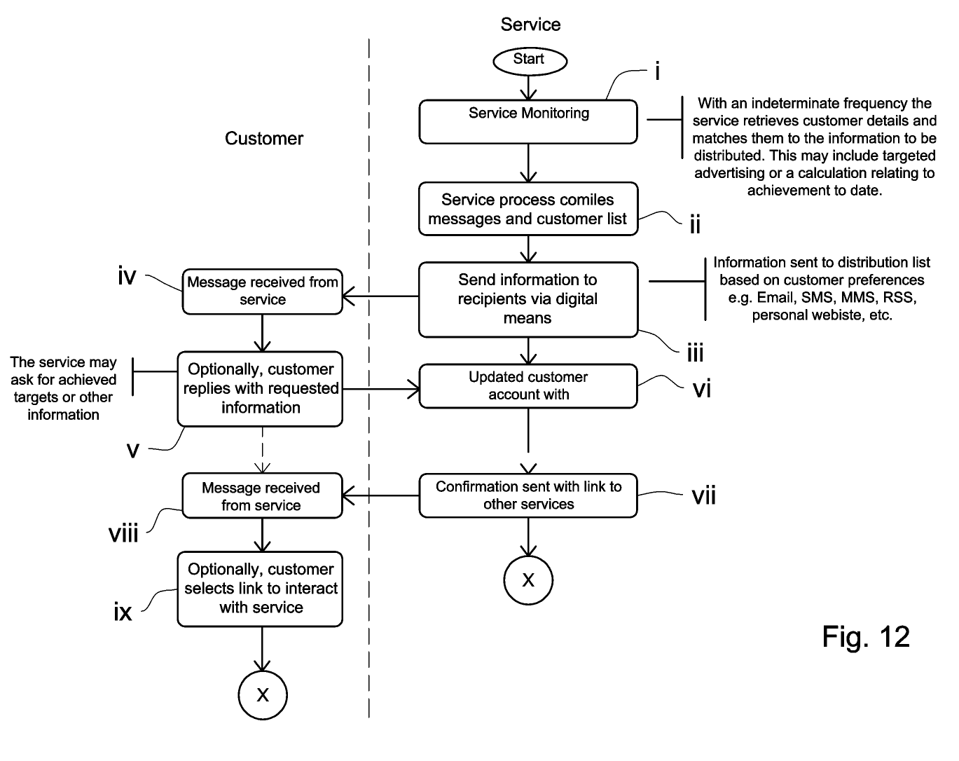

At regular intervals, for example on a daily basis, the system processor (124) of the multi-media system (120) will run a process to determine which calendar users need to be sent reminders or alerts and further interact with a service information feed database (142) or an advert feed database (144) of the multi-media system (120) [step i of FIG. 12] and compiles a list of the reminders or alerts mapped to associated calendar user's contact details, for example, mobile phone numbers or e-mail addresses, as retrieved from the customer database (128) [step ii of FIG. 12]. The system processor (124) then sends the reminders, for example as SMS, MMS or e-mail messages, to the calendar users [step iii of FIG. 12], incorporating relevant information from the service information feed and advert feed databases (142, 144) which are received by the calendar users [step iv of FIG. 12].

Upon receipt of the reminder [step iv of FIG. 12], if the reminder contains a hyperlink or URL, the user may choose to click on the link and access digital content or services, via the mobile web interface (152) from a calendar user's mobile telephone (114) or via the web interface (126) from a calendar user's PC (116). Alternatively, the calendar user may follow instructions in the reminder or may follow instructions printed on the calendar (102) to execute a number of options, in order to reply to the multi-media service with requested information [box v in FIG. 12]. For example the user may decide to turn off the reminder, ask for a further reminder at a future point in time, change the configuration of the package or provide a confirmation that they wish to access a service or content which may be part of their digital package. This information is then sent by the calendar user to the multi-media system (120) via the appropriate interface and the system processor (124) updates the customer's account in the customer database (130) as appropriate [box vi of FIG. 12]. Where the customer has confirmed they wish to access a service or content, the system processor sends a further message to the calendar user including a link, such as a hyperlink or URL to the digital service or content [step vii of FIG. 12]. The calendar user receives this message [step viii of FIG. 12] and can then interact with the content or service [step ix of FIG. 12].

For example, at a time point before Valentine's day the system processor (124) will run the process to retrieve the reminders to be sent on or before Valentine's day. The system processor (124) retrieves details of messages to be sent and other service information from the service information feed database (142) and then retrieves contact details for all calendar users subscribing to Valentine's day reminders. The system processor (124) also retrieves any relevant adverts (for example, adverts for florists) to be sent with the reminder messages from the advert feed database (144). The system processor (124) then compiles a Valentine reminder SMS, MMS, e-mail or even voicemail message and the list of mobile phone numbers or e-mails to which this message is to be sent and then executes a batch process to send the messages via the appropriate interface.

According to a further aspect of the present invention, the web link sent to the user may represent an electronic casino style chip which is delivered to a user's electronic device, in particular an electronic device supporting SMS messaging. Primarily, this would work in combination with the multi-media greeting card system or multi-media calendar system described above. The use of such a chip, as described below could be applied across numerous types of competitions, gambling or prize draws and may for example be used in regional lotteries.

A person may purchase a lottery themed and branded card or calendar which includes a prepaid entry or number of entries into the lottery.

The user follows the printed instructions on the greeting card (2) or calendar (102) and sends an SMS message containing the keyword and unique code to the short code number provided. The multi-media system checks that the codes are valid and if the codes are valid, the multi-media system opens an account on behalf of the user and enters the user into the lottery draw. The multi-media system then sends the user an SMS message confirming their entry and other relevant lottery entry information and sends the user the link, such as a hyperlink or URL to the multi-media system. The lottery entry information might include their lottery numbers and instructions on what to do if they win.

The user can then check the lottery results and if they have not won, they can delete the SMS message from their device.

The multi-media system automatically checks to see whether the user has won, and if they have won, sends the user an SMS message containing a web link and a pin number that they can use in order to set up a prize account. The user then uses the link and enters the pin number to access the web portal. They then enter necessary details to allow their age to be verified and their prize account to be set up. Then a payment of their winnings is made to their prize account and the multi-media service is updated accordingly.

One example of a multi-media gift card system would be a lottery branded card in which the digital package includes an entry into the lottery, as described above. An example of a multi-media calendar system would be a horse racing branded calendar in which the digital package includes a number of bets on major races in the sporting calendar. The multi-media system could offer the user a choice of horses in any particular race.

Where a recipient or user's digital package allows them to download digital content, for example, an image, It is possible that the recipient or user could then forward the content to their friends and family, etc., so that the content becomes widely distributed to many people. This may be desirable for example, where the content assists in advertising a product or service.

A possible data model for the multi-media system according to the present invention is shown in FIGS. 7a and 7b. It comprises two key elements, firstly the proposition data stored in the mapping in the code database (18, 128) and listed in Box (50) in FIG. 7b and the customer (the recipient or user) data listed in Box (52) in FIG. 7b, for example stored in the customer database (130). The proposition data is also shown in FIG. 7a.

The customer data (52) is created when a digital package (proposition) is first activated and is composed of a unique customer identifier, the customer's contact details (digital address) and the proposition data associated with the customer.

Each proposition is tracked using a unique proposition identifier, which is unique among all of the propositions available. Each proposition is then qualified with access information as listed in Box (56) in FIG. 7b, and shown in FIG. 7a, including the SMS short code (10, 110), keyword (9, 109), unique code (8) and bar code (11) (as supplied by the manufacturer (1, 101). In addition, each proposition includes a description of the digital package (13), a set of instructions (as displayed on the greeting card), proposition logic and one or more digital products or services (15) making up the digital package. When the proposition is activated by the customer, additional data may be associated with the access information, including one or more selected digital product or services, if a selection is available to the customer, the pin number a link (for configuration) (e.g., a URL) and the redemption status of the proposition.

As shown in Box (58) of FIG. 7b and in FIG. 7a, each digital product or service is also tracked by a unique product or service identifier, associated with a description of the product or service, digital product or service logic rules to control access and activation of one or more digital components of the digital product or service and a list of the digital components including, for example, media services, alert services and products.

The media service component may be tracked by a unique media identifier, which may be constructed from the supplier identifier (21) and a further identifier (27) supplied by the content provider (38), but may also include a description (23) of the media service, including, the media service type, for example, wallpaper, ring tone, game, audio download, etc, the location of the media service (for example, a URL) (25) and a temporary URL (27) and time stamp (29) (if access to the digital package is to be limited to a set time period) created at the activation of the proposition. Further information might also be captured.

The alert or reminder service component will also have a unique alert identifier, description and a number of possible information elements to control the frequency and nature of alerts. For example, the alert service component might specify the calendar events during a year when the customer (user) will be alerted and the location of the information feed to be included in the alerts. Alternatively, the alert service component might be customizable, allowing a customer to specify the nature, timing and dates of alerts that are important to them.

The product service component might be used to define a more interactive service e.g. a lottery ticket. The product component will again have a unique identifier but will capture information, which in the lottery ticket example, might include the date of the lottery draw, the lottery numbers, funds won, claim status.

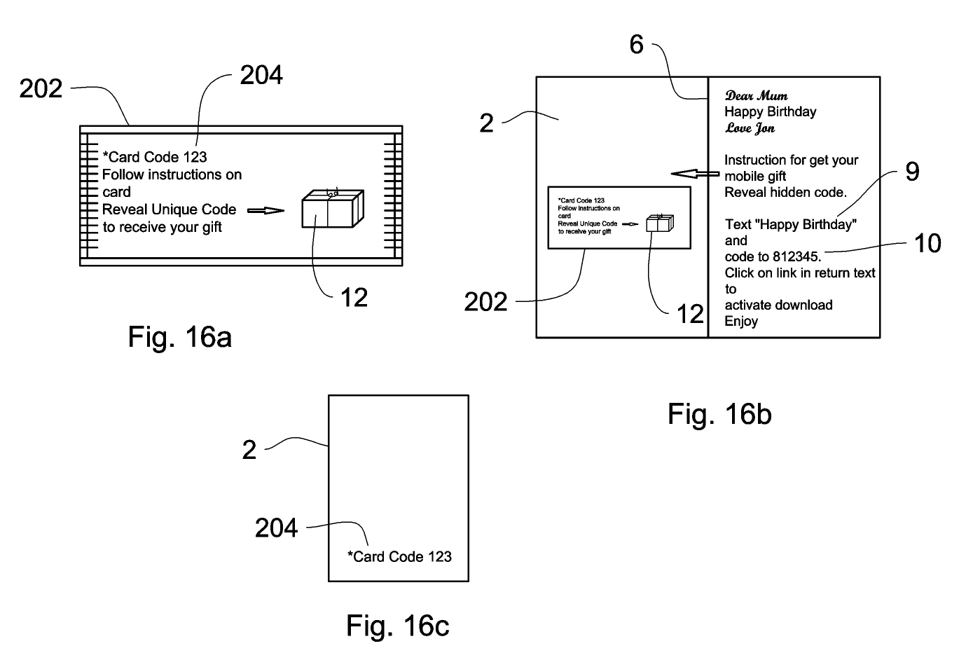

FIGS. 16a to 16c highlight an alternative way of preventing access to a unique code (8) until after a greeting card according to the present invention has been purchased. This would apply equally to the purchase of a calendar or diary according to the present invention.

The greeting card (2) is shown opened in FIG. 16b and is similar to the greeting card shown in FIGS. 1a, 1b and 2, with like parts identified by like numerals. The greeting card (2) is printed with instructions, a gift code (9) and a communication code (10), as described in relation to FIGS. 1a and 1b. However, the unique code for the greeting card is printed on a separate card (202), as shown in FIG. 16a, which is stored by a retailer in a separate place from where the greeting is displayed for sale. For example, the separate card may be stored behind a sales counter in the retailer's premises. The separate card (202) may be marked with a card code (204), which matches a card code (204) printed, for example, on the back surface of the greeting card, as is shown in FIG. 16c. Different ones of the greeting cards (2) will need to be matched with a different separate card (202) and this is done be matching the card code (204) on the separate card with that on the greeting card. The separate card (202) shown in FIG. 16a, has a removable covering (12), similar to that described in relation to FIGS. 1b and 2. The removable covering (12) can be removed in order to reveal the unique code.

When purchasing a greeting card (2) as shown in FIGS. 16b and 16c, a sender selects a greeting card (2) and takes it to a sales desk in the retail premises selling the card. At the sales desk, the sender purchases the card and during the purchasing process a sales assistant locates a separate card (202) with a card code (204) matching the card code (204) on the reverse of the greeting card (2). The sales assistant sells the greeting card (2) with the separate card (202). For example, the separate card (202) may be affixed to the greeting card (2), as is shown in FIG. 16b. This may be done by the sales assistant in the retail premise or may be done by the sender. The sender then sends the greeting card (2) and the separate card (202) to the recipient. The recipient can then access the unique code beneath the removable covering on the separate card (202) and then access the digital package associated with the greeting card. Alternatively, the greeting card (2) and separate card (202) may be purchased from an on-line shop. The on-line shop would then send the hard copy greeting card (2) and separate card (202) either to the sender or the recipient.

By storing the separate card (202) separately from the greeting card (2) in a retail premises, unauthorized access to the digital package is prevented, in situations where the greeting card is stolen or is tampered with before purchase of the greeting card.

In the example of FIGS. 16a to 16c only the unique code is printed on the separate card (202). Alternatively, any one or more of the communication code (10), gift code (9) and unique code (8) could be printed on the separate card (202). The key point to avoid unauthorized access by someone stealing or tampering with the card before purchase is to ensure that the complete set of codes are not located on the greeting card (2).

It is possible to print all of the codes (8, 9, 10) on the separate card (202). In this case it would be possible for the retailer to supply different digital packages associated with different separate cards (202) with a greeting card (2).

1. A method of enhancing a hard copy consumable printed item with a digital package supported by a multi-media system, comprising the steps of:
generating a digital package comprising digital content and/or services;
making the digital package accessible to the multi-media system;
manufacturing the printed item and including with the printed item a unique set of codes;
storing in the multi-media system a mapping between the unique set of codes and the digital package;
providing access to the digital packages to users of the printed items using the multi-media system on submission of the codes to the multi-media system.

2. The method according to claim 1 wherein the unique set of codes includes an SMS short code and comprising the step of the multi-media system receiving from a user an SMS message in order to access the digital package.

3. The method according to claim 2 wherein the set of codes includes a unique code which is required by the multi-media system in order to access the digital package, comprising the step of the multi-media system receiving the unique code in the SMS message from a user to the multi-media system.

4. The method according to claim 1 wherein the step of providing access comprises the steps of:
the multi-media system receiving a digital message from a user's electronic device incorporating the set of codes;
the multi-media system verifying the set of codes and if the codes are verified, sending a digital message to such a user's electronic device including a link to an internet site hosting the digital package.

5. The method according to claim 4 comprising the additional step of the multi-media system making the digital package available to a user via the link.

6. The method according to claim 4 comprising the additional steps of the multi-media system storing a digital address of a user's electronic device, mapped to the set of codes and providing access to the link only from that digital address mapped to the set of codes.

7. The method according to claim 4 wherein the digital message to such a user's electronic device also includes a personal identification number (pin number).

8. The method according to claim 7 comprising the additional step of the multi-media system providing access to the digital package in response to a user inputting the pin number on the internet site.

9. The method according to claim 4 comprising the step of the multi-media system generating the internet site.

10. The method according to claim 4 comprising the step of the multi-media system time stamping the link and invalidating the link after a predetermined time period.

11. The method according to claim 4 comprising the additional step of the multi-media system providing access to the internet site for a user to personalize the digital package.

12. The method according to claim 1 comprising the additional step of the multi-media system marking the set of codes as redeemed when the digital package has been used up and thereafter denying access to the digital package with that set of codes.

13. The method according to claim 1 wherein at least one of the codes of the set of codes included with the printed item is covered by a removable cover

14. The method according to claim 1 wherein the consumable item is a calendar.

15. The method according to claim 1 wherein the consumable item is a greeting card.

16. A multi-media system for enhancing a hard copy consumable printed item with a digital package, comprising:
at least one digital package comprising digital content and/or services;
the printed item comprising a unique set of codes; and
a system processor for accessing the digital packages, for storing a mapping between the unique set of codes and the digital package and for providing access to the digital packages to users of the printed items on submission of the codes.

17. The multi-media system according to claim 16 wherein the system processor comprises means for accessing the digital packages from at least one content provider.

18. A hard copy consumable printed item suitable for enhancement by the multi-media system of claim 16 and comprising the unique set of codes.

19. An item according to claim 18 wherein at least one of codes of the unique set of codes is covered by a removable cover.
